(19) United States
(12) Patent Application Publication
(10) Pub. No.: US 2017/0177212 A1
(43) Pub. Date: Jun. 22, 2017

(54) GAME-LIKE NAVIGATION FOR A MOBILE DEVICE

(71) Applicant: TARGET BRANDS INC., Minneapolis, MN (US)

(72) Inventor: Mitch Ernst, Minneapolis, MN (US)

(21) Appl. No.: 14/979,063

(22) Filed: Dec. 22, 2015

(51) Int. Cl. G06F 3/0488; G06F 3/01; G06F 3/0484; G06Q 30/06; G06F 3/0346

(52) U.S. Cl. CPC G06F 3/04886; G06Q 30/0643; G06F 3/0346; G06F 3/04845; G06F 3/016

(57) ABSTRACT

Systems and methods for navigation on a mobile device are disclosed. The method includes displaying, on a display of a mobile device, a user interface, the user interface including a game piece virtually movable across the display of the mobile device and a target that can virtually receive the game piece; detecting a physical motion of the mobile device; causing the game piece to virtually move across the display of the mobile device in response to detecting the physical motion; and causing an action on the mobile device in response to the game piece being virtually received by the target.

### FIELD

This disclosure relates generally to mobile devices such as, but not limited to, cellular phones, smart phones, personal digital assistants (PDAs), tablet devices, wearable devices such as smart watches, or the like. More specifically, the disclosure relates to navigating a user interface for a mobile device by physically moving the mobile device.

### BACKGROUND

Consumers purchase products in retail stores and via retail websites accessible from the Internet. Shopping via a retail website allows consumers to interact with pictures, videos, and/or audio clips relating to the products the consumer is contemplating purchasing. Often, shopping via the retail website allows the consumer to read reviews by other consumers, search for related products, search for products that other consumers bought at the same time, or the like. In some instances, the inventory of products available from a retailer through the retail website can be different from the products available at the retail store.

Improved ways to enhance a consumer's shopping experience are desirable.

### SUMMARY

This disclosure relates generally to mobile devices such as, but not limited to, cellular phones, smart phones, personal digital assistants (PDAs), tablet devices, wearable devices (e.g., smart watches, etc.), or the like. More specifically, the disclosure relates to navigating a user interface for a mobile device by physically moving the mobile device.

In an embodiment, a user interface is navigable by virtually moving a game piece across a display of a mobile device in response to physically moving the mobile device (e.g., by a user of the mobile device). The user interface can include one or more targets to which the game piece can be moved in order to cause an action on the mobile device.

In an embodiment, the game piece can be spherical and the target can be a cup into which the sphere can be virtually placed. In an embodiment, the game piece can be a shape other than spherical and the target can be designed to permit the game piece to virtually fit therein. For example, the game piece can be cuboidal and the target can be square.

In an embodiment, the user can cause the game piece to virtually traverse the display of the mobile device by physically moving the mobile device (e.g., tipping the mobile device).

A mobile device-implemented method is also disclosed. The method includes displaying, on a display of a mobile device, a user interface, the user interface including a game piece virtually movable across the display of the mobile device and a target for virtually receiving the game piece; detecting a physical motion of the mobile device; causing the game piece to virtually move across the display of the mobile device in response to detecting the physical motion; and causing an action on the mobile device in response to the game piece being virtually received by the target.

A user interface for a mobile device, the mobile device including a display, one or more motion sensors, and an output device is also disclosed. The user interface includes a game piece virtually movable across the display of the mobile device based on a value determined from the one or more motion sensors; and one or more stationary targets for virtually receiving the game piece, wherein in response to the game piece being virtually received by one of the one or more stationary targets, an action is generated on the mobile device.

A system is also disclosed. The system includes a mobile device having a display, an output means, and a motion detecting means. The system further includes an application loadable onto the mobile device, the application providing a user interface for virtually moving a game piece across the display of the mobile device and one or more targets for the game piece, the user interface displayable on the display of the mobile device, the game piece being movable by a user in response to a physical movement of the mobile device, wherein an action on the mobile device is generated in response to the game piece being virtually received by one of the targets.

### BRIEF DESCRIPTION OF THE DRAWINGS

References are made to the accompanying drawings that form a part of this disclosure, and which illustrate embodiments in which the systems and methods described in this specification can be practiced.

FIG. 1 illustrates a user interface for a mobile device having game-like navigation as described herein, according to an embodiment.

FIG. 2 illustrates a user interface for a mobile device having game-like navigation as described herein, according to an embodiment.

FIG. 3 illustrates a user interface for a mobile device having game-like navigation as described herein, according to an embodiment.

FIG. 4 is a schematic diagram for an architecture for a computing device, according to an embodiment.

Like reference numbers represent like parts throughout.

### DETAILED DESCRIPTION

Mobile devices such as, but not limited to, cellular phones, smart phones, personal digital assistants (PDAs), tablet devices, wearable devices such as smart watches, or the like, generally include a plurality of sensors for sensing motion. As a result, the mobile device can be physically moved (e.g., tipped, tilted, etc.) in various directions, with the direction and speed of the motion being captured by the plurality of sensors.

In an embodiment, a user interface can include a game piece (e.g., a ball, etc.) which can virtually move across a display of the mobile device. The user interface, based on the sensors, can cause the game piece to virtually move across the display of the mobile device in a direction that the mobile device is physically moved. In an embodiment, the game piece can also be virtually moved at a speed that is based on how the user physically moves the mobile device. The user interface can also include a target toward which the user can attempt to navigate the game piece. In an embodiment, the game piece can be a ball and the target can be a cup for receiving the ball. As a result, the user of the mobile device can cause an action by virtually moving the ball to the cup of the user interface. In this manner, a mobile device may have a user experience in which the user experiences game-like navigation, and is able to navigate through various user interfaces by virtually moving a game piece to a target.

The game-like navigation and the various user interfaces can, for example, be in an application for a mobile device that is provided by a retailer. Such game-like navigation may enable a user to both shop for one or more products sold by the retailer as well as navigate through a user interface in a game-like manner.

An action on the mobile device, as used herein, can include a variety of different actions such as, but not limited to, a sound, a vibration, a display of a different user interface, a display of a message, a change in color of the user interface, a change in the game piece, or the like. In an embodiment, the user may, therefore, cause the game piece to virtually traverse the display instead of, for example, touching the display of the device to make a selection (e.g., with a user's finger, a stylus, or the like).

In an embodiment, an action on a mobile device includes navigating a user interface of the mobile device. Navigating a user interface of the mobile device, as used in this specification, includes, for example, changing views (e.g., selecting an option to switch from a first user interface to a second user interface, etc.) when a mobile device user is browsing a website or application provided by, for example, a retailer.

A game piece, as used in this specification, includes a virtual representation of a game piece displayed on a mobile device. The game piece can have a variety of shapes and/or sizes. The game piece can be virtually traversed across a display of the mobile device.

A target, as used in this specification, includes a virtual representation of a target for virtually receiving a game piece on a mobile device. The target can have a variety of shapes and/or sizes based on a corresponding game piece.

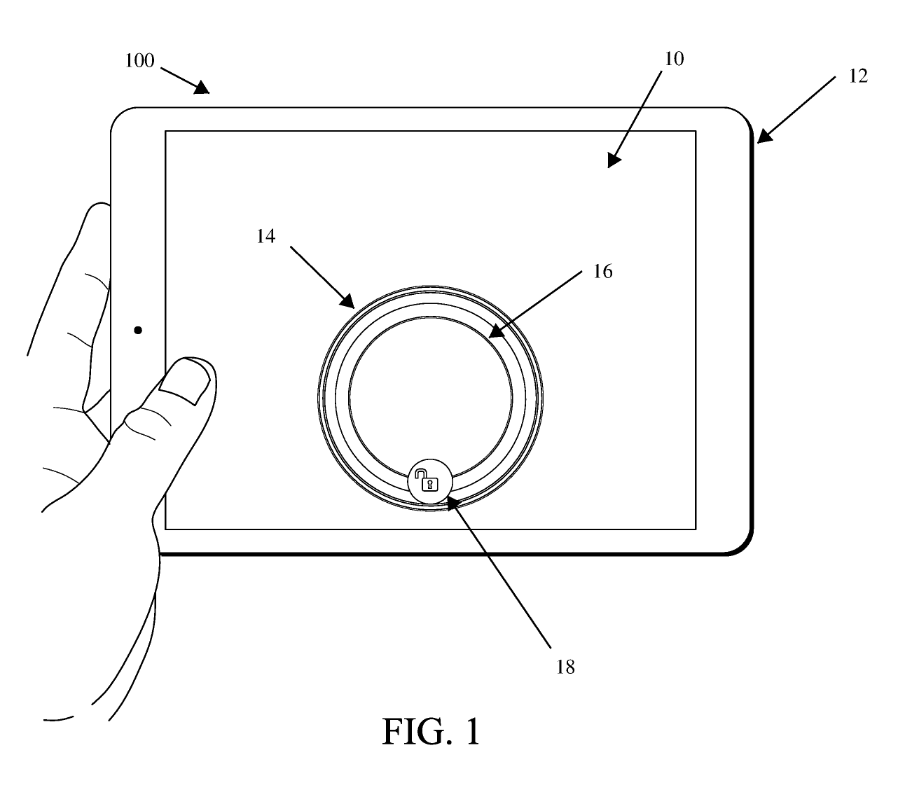

FIG. 1 illustrates a user interface 100 for a mobile device 12 having game-like navigation as described herein, according to an embodiment. The mobile device 12 can include a variety of mobile devices such as, but not limited to, cellular phones, smart phones, personal digital assistants (PDAs), tablet devices, wearable devices such as smart watches, or the like.

The mobile device 12 includes a display area 10. The display area 10 is illustrated as displaying the user interface 100 for an application for the mobile device 12. The user interface 100 includes a target 14 and a game piece 16. In the illustrated embodiment, the target 14 is illustrated as circular and the game piece 16 is circular. It will be appreciated that the game piece 16 can alternatively be spherical. In an embodiment, the target 14 can alternatively be referred to as a “cup” and the game piece 16 can be referred to as a “ball.” In such an embodiment, the game-like navigation may be referred to as a ball-and-cup navigation. It will be appreciated that the size and geometry of the target 14 and the game piece 16 are not intended to be limiting. The target 14 and the game piece 16 generally have a configuration in which the game piece 16 is intended to be virtually receivable by the target 14. Accordingly, other sizes and geometrical shapes for the target 14 and/or the game piece 16 may function according to principles generally described in this specification.

The user interface 100 includes a virtual indicator 18, which is shown as an unlocked padlock in the illustrated embodiment. It will be appreciated that the virtual indicator 18 can be varied. Generally, the virtual indicator 18 can be used to provide an indication to a user that virtually navigating the game piece 16 to the target 14 has accomplished an action on the mobile device 12. In the illustrated embodiment, for example, the game piece 16 is disposed within the target 14 as a result of the user virtually navigating the game piece 16 to the target 14 by physically moving the mobile device 12. The virtual indicator 18, which in the illustrated embodiment can indicate, for example, that the user has virtually unlocked some functionality as a result of virtually navigating the game piece 16 to the target 14. It will be appreciated that the virtual indicator 18 can be a locked padlock prior to the game piece 16 being virtually received by the target 14.

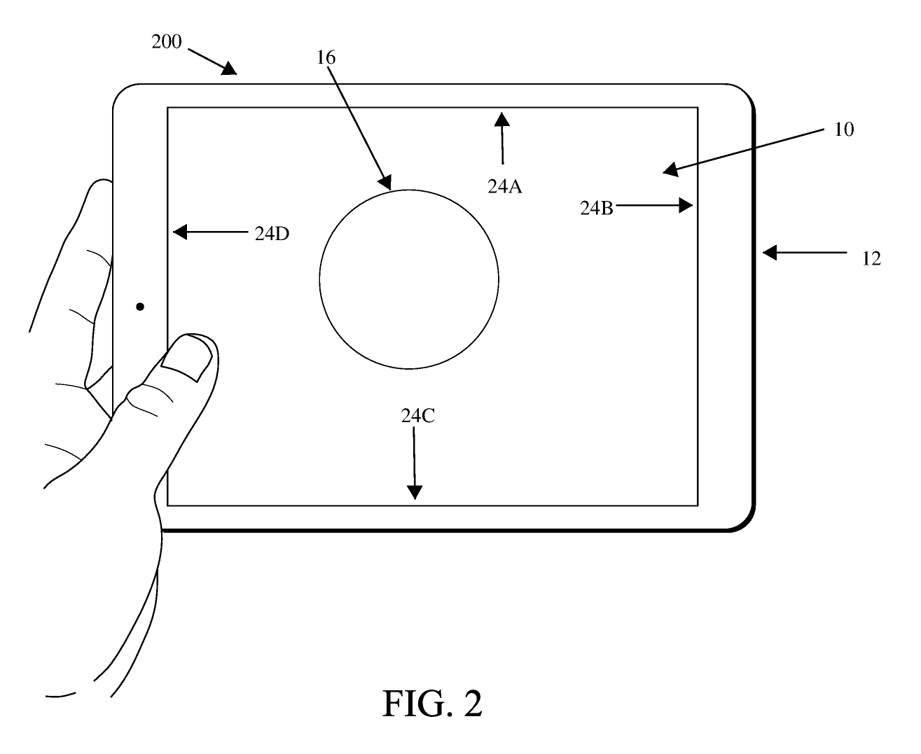

FIG. 2 illustrates a user interface 200 for a mobile device 12 having game-like navigation as described herein, according to an embodiment. The user interface 200 includes the game piece 16 as displayed on the display 10 of the mobile device 12.

For illustrative purposes only, the user interface 200 does not include a target (e.g., target 14 of FIG. 1). A user can cause the game piece 16 to virtually traverse the display 10 based on a physical movement of the mobile device 12. For example, the user can tilt the mobile device 12. The mobile device 12 can include, for example, one or more built-in sensors to determine a physical motion of the mobile device 12 by the user. For example, the one or more built-in sensors can include accelerometers, gyroscopes, or the like. As a result of the user's physical movement of the mobile device 12, the game piece 16 can be displayed as virtually traversing the display 10 of the mobile device 12 in any direction corresponding to the physical movement of the mobile device 12.

As described in FIG. 1, the goal of the movement of the game piece 16 may be to virtually move the game piece 16 to a target. In an embodiment, the virtual movement of the game piece 16 across the display 10 may also cause a variety of actions on the mobile device 12 when an extent (e.g., viewing edge of the display 10) 24A-24D of the display 10 is virtually contacted. The action can be different depending upon which of the extents 24A-24D is virtually contacted. For example, as viewed on the page, a right extent 24B and a left extent 24D can cause a change in the user interface that is viewed when the game piece 16 virtually contacts the extent 24B or 24D. In an embodiment, this could include moving “back” an interface when virtually contacting the left extent 24D or “forward” an interface when virtually contacting the right extent 24B. In an embodiment, virtually contacting a top extent 24A or bottom extent 24C can result in a different action on the mobile device 12. For example, a vibration can be generated by a vibrator of the mobile device 12 when one or more of the top and bottom extents 24A, 24C is virtually contacted by the game piece 16.

In an embodiment, other types of actions on the mobile device 12 may be possible. Other types of actions on the mobile device 12 include, but are not limited to, changing music that may be playing through a speaker of the mobile device 12, changing a color of the interface being displayed on the display 10 of the mobile device 12, changing a color of the game piece 16, changing a geometry (e.g., size and/or shape) of the game piece 16, or the like. It will be appreciated that one or more of these actions can be initiated when the game piece 16 virtually contacts one of the extents 24A-24D of the display 10 of the mobile device 12.

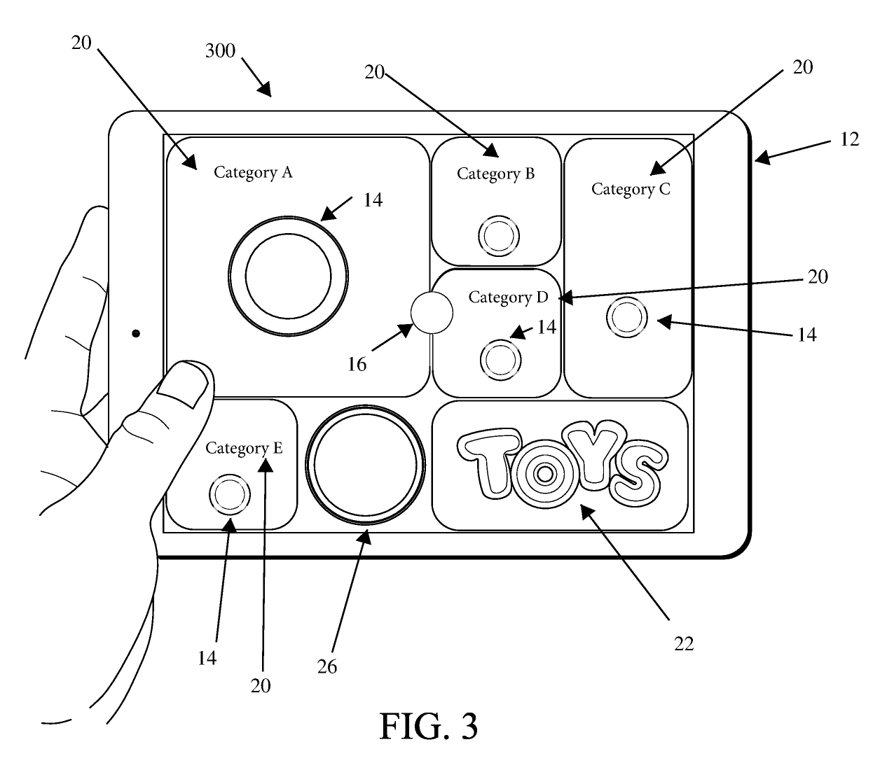

FIG. 3 illustrates a user interface 300 for the mobile device 12 having game-like navigation as described herein, according to an embodiment. The user interface 300 includes a user interface title 22. In the illustrated embodiment, the user interface title 22 is “TOYS.” It will be appreciated that the text is not intended to be limiting. Accordingly, the user interface title 22 can be any text. When used in an application for a retailer, the user interface title 22 may correspond to a category of products that the retailer sells. For example, the user interface title 22 can include Toys, Electronics, Clothes, or any other suitable category of items which the retailer sells.

As illustrated in FIG. 3, a plurality of categories 20 is displayed on the display 10. The categories 20 may be based on the user interface title 22. For example, in the illustrated embodiment the user interface title 22 is “TOYS,” and the categories 20 may be types of toys, brands of toys, characters portrayed in toys, or the like.

The categories 20 (category A-E) each include a target 14. A user can virtually traverse the game piece 16 across the display 10 by physically moving the mobile device 12 to attempt to virtually land the game piece 16 in one of the targets 14. An action on the mobile device 12 can be generated in response to the game piece 16 being virtually received by the target 14. One type of action on the mobile device 12 can, for example, include selecting one of the categories 20 that the user would like to browse.

In an embodiment, the user interface 300 can include a home target 26 which is not associated with one of the categories 20. The home target 26 can generate a different action on the mobile device 12, such as, but not limited to, navigating the user to a home interface which includes, for example, various product categories identified as the user interface title 22. In an embodiment, the home target 26 can alternatively cause a user to, for example, close the user interface 300 to, for example, return to a home screen of the mobile device 12.

If the game piece 16 is virtually received by one of the targets 14 associated with the various categories 20, an action on the mobile device 12 may include providing a user interface that allows the user to browse products within that category 20. It will be appreciated that the user interface 300 can include aspects of the user interface 200. For example, the extents of the display 10 (not labeled in FIG. 3) may cause other actions on the mobile device.

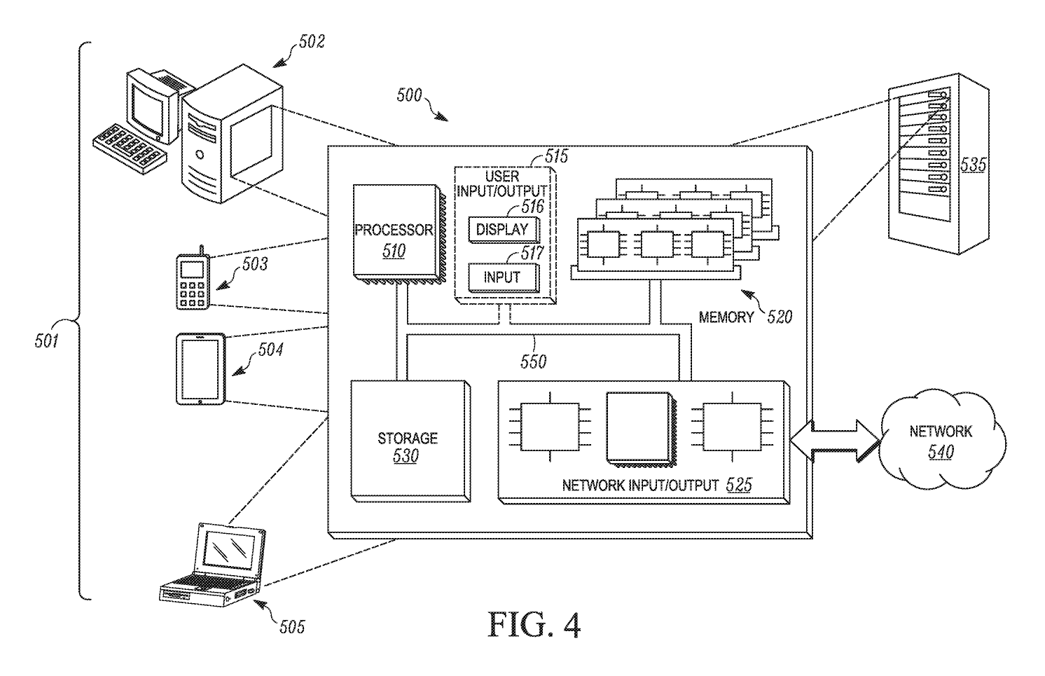

FIG. 4 is a schematic diagram of an architecture for a computer device 500, according to an embodiment. The computer device 500 and any of the individual components thereof can be used for any of the operations described in accordance with any of the computer-implemented methods described herein. It will be appreciated that the computer device 500 can be a mobile device as described in this specification.

The computer device 500 generally includes a processor 510, memory 520, a network input/output (I/O) 525, storage 530, and an interconnect 550. The computer device 500 can optionally include a user I/O 515, according to some embodiments. The computer device 500 can be in communication with one or more additional computer devices 500 through a network 540.

The computer device 500 is generally representative of hardware aspects of a variety of user devices 501 and a server device 535. The illustrated user devices 501 are examples and are not intended to be limiting. Examples of the user devices 501 include, but are not limited to, a desktop computer 502, a cellular/mobile phone 503, a tablet device 504, and a laptop computer 505. It is to be appreciated that the user devices 501 can include other devices such as, but not limited to, a personal digital assistant (PDA), a video game console, a television, or the like. In an embodiment, the user devices 501 can alternatively be referred to as client devices 501. In such embodiments, the client devices 501 can be in communication with the server device 535 through the network 540. One or more of the client devices 501 can be in communication with another of the client devices 501 through the network 540 in an embodiment.

The processor 510 can retrieve and execute programming instructions stored in the memory 520 and/or the storage 530. The processor 510 can also store and retrieve application data residing in the memory 520. The interconnect 550 is used to transmit programming instructions and/or application data between the processor 510, the user I/O 515, the memory 520, the storage 530, and the network I/O 540. The interconnect 550 can, for example, be one or more busses or the like. The processor 510 can be a single processor, multiple processors, or a single processor having multiple processing cores. In an embodiment, the processor 510 can be a single-threaded processor. In an embodiment, the processor 510 can be a multi-threaded processor.

The user I/O 515 can include a display 516 and/or an input 517, according to some embodiments. It is to be appreciated that the user I/O 515 can be one or more devices connected in communication with the computer device 500 that are physically separate from the computer device 500. For example, the display 516 and input 517 for the desktop computer 502 can be connected in communication but be physically separate from the computer device 500. In an embodiment, the display 516 and input 517 can be physically included with the computer device 500 for the desktop computer 502. In an embodiment, the user I/O 515 can physically be part of the user device 501. For example, the cellular/mobile phone 503, the tablet device 504, and the laptop 505 include the display 516 and input 517 that are part of the computer device 500. The server device 535 generally may not include the user I/O 515. In an embodiment, the server device 535 can be connected to the display 516 and input 517. In an embodiment, the user I/O 515 can include a variety of output means such as, but not limited to, an output device. For example, the output means can include a vibrator to cause a vibration. In an embodiment the user I/O 515 can include an output means for generating a sound, such as, but not limited to, a speaker.

The display 516 can include any of a variety of display devices suitable for displaying information to the user. Examples of devices suitable for the display 516 include, but are not limited to, a cathode ray tube (CRT) monitor, a liquid crystal display (LCD) monitor, a light emitting diode (LED) monitor, or the like. The input 517 can include any of a variety of input devices or means suitable for receiving an input from the user. Examples of devices suitable for the input 517 include, but are not limited to, a keyboard, a mouse, a trackball, a button, a voice command, a proximity sensor, an ocular sensing device for determining an input based on eye movements (e.g., scrolling based on an eye movement), or the like. It is to be appreciated that combinations of the foregoing inputs 517 can be included for the user devices 501. In an embodiment the input 517 can be integrated with the display 516 such that both input and output are performed by the display 516. In an embodiment the input can include 517 one or more motion sensors for determining a motion of the computer device 500. The one or more motion sensors can include, but are not limited to, an accelerometer, gyroscope, or the like.

The memory 520 is generally included to be representative of a random access memory such as, but not limited to, Static Random Access Memory (SRAM), Dynamic Random Access Memory (DRAM), or Flash. In an embodiment, the memory 520 can be a volatile memory. In an embodiment, the memory 520 can be a non-volatile memory. In an embodiment, at least a portion of the memory can be virtual memory.

The storage 530 is generally included to be representative of a non-volatile memory such as, but not limited to, a hard disk drive, a solid state device, removable memory cards, optical storage, flash memory devices, network attached storage (NAS), or connections to storage area network (SAN) devices, or other similar devices that may store non-volatile data. In an embodiment, the storage 530 is a computer readable medium. In an embodiment, the storage 530 can include storage that is external to the computer device 500, such as in a cloud.

The network I/O 525 is configured to transmit data via a network 540. The network 540 may alternatively be referred to as the communications network 540. Examples of the network 540 include, but are not limited to, a local area network (LAN), a wide area network (WAN), the Internet, or the like. In an embodiment, the network I/O 525 can transmit data via the network 540 through a wireless connection using WiFi, Bluetooth, or other similar wireless communication protocols. In an embodiment, the computer device 500 can transmit data via the network 540 through a cellular, 3G, 4G, or other wireless protocol. In an embodiment, the network I/O 525 can transmit data via a wire line, an optical fiber cable, or the like. It is to be appreciated that the network I/O 525 can communicate through the network 540 through suitable combinations of the preceding wired and wireless communication methods.

The server device 535 is generally representative of a computer device 500 that can, for example, respond to requests received via the network 540 to provide, for example, data for rendering a website on the user devices 501. The server 535 can be representative of a data server, an application server, an Internet server, or the like.

Aspects described herein can be embodied as a system, method, or a computer readable medium. In an embodiment, the aspects described can be implemented in hardware, software (including firmware or the like), or combinations thereof. Some aspects can be implemented in a non-transitory, tangible computer readable medium, including computer readable instructions for execution by a processor. Any combination of one or more computer readable medium(s) can be used.

The computer readable medium can include a computer readable signal medium and/or a computer readable storage medium. A computer readable storage medium can include any tangible medium capable of storing a computer program for use by a programmable processor to perform functions described herein by operating on input data and generating an output. A computer program is a set of instructions that can be used, directly or indirectly, in a computer system to perform a certain function or determine a certain result. Examples of computer readable storage media include, but are not limited to, a floppy disk; a hard disk; a random access memory (RAM); a read-only memory (ROM); a semiconductor memory device such as, but not limited to, an erasable programmable read-only memory (EPROM), an electrically erasable programmable read-only memory (EEPROM), Flash memory, or the like; a portable compact disk read-only memory (CD-ROM); an optical storage device; a magnetic storage device; other similar device; or suitable combinations of the foregoing. A computer readable signal medium can include a propagated data signal having computer readable instructions. Examples of propagated signals include, but are not limited to, an optical propagated signal, an electro-magnetic propagated signal, or the like. A computer readable signal medium can include any computer readable medium that is not a computer readable storage medium that can propagate a computer program for use by a programmable processor to perform functions described herein by operating on input data and generating an output.

Some embodiments can be provided to an end-user through a cloud-computing infrastructure. Cloud computing generally includes the provision of scalable computing resources as a service over a network (e.g., the Internet or the like).

The terminology used in this Specification is intended to describe particular embodiments and is not intended to be limiting. The terms “a,” “an,” and “the” include the plural forms as well, unless clearly indicated otherwise. The terms “comprises” and/or “comprising,” when used in this Specification, specify the presence of the stated features, integers, steps, operations, elements, and/or components, but do not preclude the presence or addition of one or more other features, integers, steps, operations, elements, and/or components.

With regard to the preceding description, it is to be understood that changes may be made in detail, especially in matters of the construction materials employed and the shape, size, and arrangement of parts without departing from the scope of the present disclosure. This Specification and the embodiments described are exemplary only, with the true scope and spirit of the disclosure being indicated by the claims that follow.

What is claimed is:

1. A mobile device-implemented method, comprising:
displaying, on a display of a mobile device, a user interface, the user interface including a game piece virtually movable across the display of the mobile device and a target that can virtually receive the game piece;
detecting a physical motion of the mobile device;
causing the game piece to virtually move across the display of the mobile device in response to detecting the physical motion; and
causing an action on the mobile device in response to the game piece being virtually received by the target.

2. The computer-implemented method according to claim 1, the causing an action on the mobile device including generating a vibration by the mobile device, generating a sound by the mobile device, and/or displaying another user interface on the display of the mobile device.

3. The computer-implemented method according to claim 1, wherein a geometry and size of the target is based on a geometry and size of the game piece such that the target can virtually receive the game piece.

4. The computer-implemented method according to claim 1, wherein the game piece is spherical and the target is circular.

5. The computer-implemented method according to claim 1, wherein the game piece is a ball and the target is a cup.

6. The computer-implemented method according to claim 1, wherein the user interface displays a plurality of targets for the game piece, wherein each of the targets causes a different action on the mobile device in response to the game piece being virtually received by a particular one of the targets.

7. A user interface for a mobile device, the mobile device including a display on which the user interface can be displayed, one or more motion sensors, and an output device, comprising:
a game piece virtually movable across the display of the mobile device based on a value determined from the one or more motion sensors; and
a stationary target that can virtually receive the game piece, wherein in response to the game piece being virtually received by the stationary target, an action of the mobile device is generated.

8. The user interface for a mobile device according to claim 7, wherein the action includes a vibration generated by the output device of the mobile device.

9. The user interface for a mobile device according to claim 7, wherein the action includes a sound generated by the output device of the mobile device.

10. The user interface according to claim 7, wherein the action includes another user interface that is displayed on the display of the mobile device.

11. The user interface according to claim 7, wherein the game piece is virtually moved in response to a motion sensed by the one or more motion sensors.

12. The user interface according to claim 7, further comprising a plurality of stationary targets, wherein each of the plurality of stationary targets can virtually receive the game piece and a different action on the mobile device can be associated with each of the plurality of targets.

13. A system, comprising:
a mobile device having a display, an output means, and a motion detecting means; and
an application loadable onto the mobile device, the application providing a user interface for virtually moving a game piece across the display of the mobile device and one or more targets for the game piece, the user interface displayable on the display of the mobile device, the game piece being movable by a user in response to a physical movement of the mobile device, wherein an action on the mobile device is generated in response to the game piece being virtually received by one of the targets.

14. The system according to claim 13, wherein the physical movement of the mobile device is determined by the motion detecting means.

15. The system according to claim 13, wherein the motion detecting means includes one or more sensors of the mobile device.

16. The system according to claim 13, wherein the action of the mobile device is generated by the output means of the mobile device.

17. The system according to claim 16, wherein the output means includes a vibrator and the action on the mobile device includes generating a vibration.

18. The system according to claim 16, wherein the output means includes a speaker and the action on the mobile device includes generating a sound.

19. The system according to claim 13, wherein the action on the mobile device includes providing another user interface displayable of the mobile device.
